(19) United States
(12) Patent Application Publication
(10) Pub. No.: US 2026/0162904 A1
(43) Pub. Date: Jun. 11, 2026

(54) MULTILAYER ELECTRONIC COMPONENT

(71) Applicant: SAMSUNG ELECTRO-MECHANICS CO., LTD., Suwon-si (KR)

(72) Inventors: Chae Min PARK, Suwon-si (KR); Yoo Jeong LEE, Suwon-si (KR); So Jung AN, Suwon-si (KR); So Eun CHOI, Suwon-si (KR); Jung Won PARK, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/312,000

(22) Filed: Aug. 27, 2025

(30) Foreign Application Priority Data
Dec. 6, 2024 (KR) 10-2024-0180766
Feb. 28, 2025 (KR) 10-2025-0026324

(51) Int. Cl. H01G 4/30; H01G 4/232

(52) U.S. Cl. CPC H01G 4/30; H01G 4/232

(57) ABSTRACT

A multilayer electronic component includes: a body including a dielectric layer with a first internal electrode and a second internal electrode alternately disposed, with the dielectric layer interposed therebetween; a first external electrode disposed on the body and connected to the first internal electrode; and a second external electrode disposed on the body, connected to the second internal electrode, and spaced apart from the first external electrode, wherein a first region, on a surface of the body, disposed between the first external electrode and the second external electrode has an uneven shape including a plurality of peaks and a plurality of valleys, and average depths D1 and D2 are different from each other when D1 indicates an average depth of the uneven shape in a central portion of the first region, and D2 indicates an average depth of the uneven shape in an outer portion of the first region.

### CROSS-REFERENCE TO RELATED APPLICATION(S)

This application claims the benefit of priority to Korean Patent Application Nos. 10-2024-0180766 and 10-2025-0026324 filed on Dec. 6, 2024 and Feb. 28, 2025 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a type of multilayer electronic component, is a chip-type capacitor that charges or discharges electric power by being mounted on a printed circuit board of various electronic products such as image display devices including a liquid crystal display (LCD) and a plasma display panel (PDP), computers, smartphones, mobile phones, and circuits such as the on-board charger (OBC) and direct current (DC) to direct current (DC) converter of an electric vehicle.

Electrochemical ion migration (ECM) is a failure that may occur during an operation of the MLCC, and refers to a phenomenon in which moisture is adsorbed onto a surface of the MLCC, and reacts with external electrodes to form metal ions, and the metal ions ionized due to an electric field move toward a negative electrode, couple with electrons after moving to the negative electrode, and are precipitated as metal to form a plating bridge between the external electrodes. The ion migration may cause a short circuit between terminals of the external electrodes, reduce performance of the MLCC due to increased leakage current, and shorten a lifespan of the MLCC when the MLCC is used in a high-temperature and high-humidity environment.

Conventionally, a method has been used to suppress or delay occurrence of ion migration by applying a water-repellent coating to the surface of a MLCC body to increase a wetting angle of water droplets, thereby causing the water droplets to spread less on the surface of the MLCC.

However, a water-repellent coating layer including a fluorine-based or silane-based compound belongs to a resin layer rather than a particle-based coating layer, and may therefore have difficulty in implementing a superhydrophobic surface having a wetting angle of 150 degrees or more.

### SUMMARY

An aspect of the present disclosure is to provide a multilayer electronic component having improved moisture-resistance reliability by mitigating occurrence of electrochemical ion migration in the multilayer electronic component.

Another aspect of the present disclosure is to provide a multilayer electronic component that implements a water-droplet movement pattern capable of suppressing occurrence of ion migration for each size of the multilayer electronic component.

Another aspect of the present disclosure is to provide a body surface structure of a multilayer electronic component that enables a body surface to be superhydrophobic.

However, the present disclosure is not limited to the description above, and may be more readily understood in the description of exemplary embodiments of the present disclosure.

According to an aspect of the present disclosure, a multilayer electronic component includes: a body including a dielectric layer with a first internal electrode and a second internal electrode alternately disposed, with the dielectric layer interposed therebetween; a first external electrode disposed on the body and connected to the first internal electrode; and a second external electrode disposed on the body, connected to the second internal electrode, and spaced apart from the first external electrode, wherein a first region, on a surface of the body disposed between the first external electrode and the second external electrode, has an uneven shape including a plurality of peaks and a plurality of valleys, and average depths D1 and D2 are different from each other when D1 indicates an average depth of the uneven shape in a central portion of the first region, and D2 indicates an average depth of the uneven shape in an outer portion of the first region.

According to another aspect of the present disclosure, a multilayer electronic component includes: a body including a dielectric layer with a first internal electrode and a second internal electrode alternately disposed, with the dielectric layer interposed therebetween; a first external electrode disposed on the body and connected to the first internal electrode; and a second external electrode disposed on the body, connected to the second internal electrode, and spaced apart from the first external electrode, wherein a first region, on a surface of the body, disposed between the first external electrode and the second external electrode, has an uneven shape including a plurality of peaks and a plurality of valleys, and average pitches P1 and P2 are different from each other wherein an average pitch indicates an average value of a gap between any peak of the uneven shape and a peak adjacent thereto, P1 indicates an average pitch of the uneven shape in a central portion of the first region, and P2 indicates an average pitch of the uneven shape in an outer portion of the first region.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an exemplary embodiment;

FIG. 2 is a cross-sectional view taken along line I-I′ in FIG. 1;

FIG. 3 is a plan view showing an enlarged uneven shape of a first region according to an exemplary embodiment;

FIG. 4 is an enlarged view of region U in FIG. 3;

FIG. 5 is a cross-sectional view showing another example for distinguishing the first region according to an exemplary embodiment;

FIG. 6 is a cross-sectional view taken along line II-II′ in FIG. 1;

FIG. 7 is an exploded perspective view of a body according to an exemplary embodiment;

FIG. 8 is a schematic perspective view of the multilayer electronic component according to an exemplary embodiment;

FIG. 9 is a cross-sectional view taken along line III-III′ in FIG. 8; and

FIG. 10 is a plan view showing enlarged shapes of the first region and a coating layer in FIG. 9.

### DETAILED DESCRIPTION

Hereinafter, exemplary embodiments of the present disclosure are described with reference to specific exemplary embodiments and the accompanying drawings. However, the exemplary embodiments of the present disclosure may be modified in many different ways, and the scope of the present disclosure is not limited to the exemplary embodiments described below. In addition, the exemplary embodiments of the present disclosure are provided to more fully describe the present disclosure to those skilled in the art. Therefore, the shape and dimension of components in the drawings may be exaggerated for clarity, and the same reference numerals are used to designate the same components.

In addition, in order to clearly describe the present disclosure in the drawings, parts not related to the description are omitted, and the size and thickness of each component shown in the drawings are arbitrarily illustrated for convenience of description, and accordingly, the present disclosure is not necessarily limited to what is shown. In addition, components having the same function within the scope of the same idea are designated by the same reference numerals. Furthermore, throughout the specification, when a portion is referred to as “including” a component, it indicates that the corresponding portion does not exclude other components unless specifically stated otherwise, and may further include other components.

In addition, in the drawings, an X-direction refers to a thickness direction, a Y-direction refers to a length direction, and a Z-direction refers to a width direction, and a stacking direction of internal electrodes or dielectric layers may be the thickness direction or the width direction.

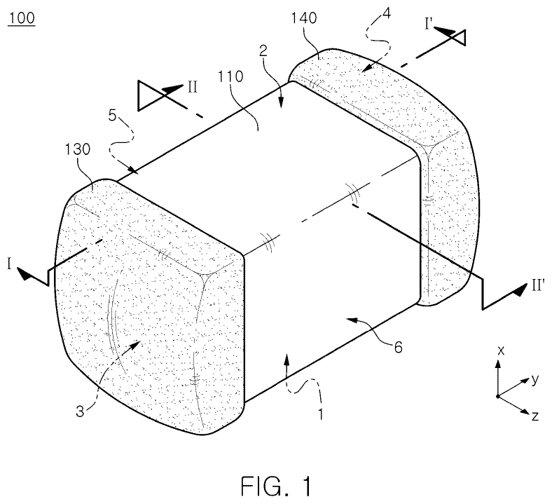

FIG. 1 is a schematic perspective view of a multilayer electronic component according to an exemplary embodiment.

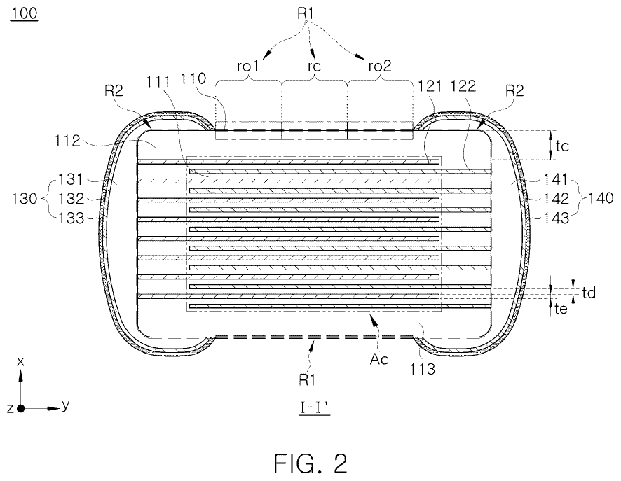

FIG. 2 is a cross-sectional view taken along line I-I′ in FIG. 1.

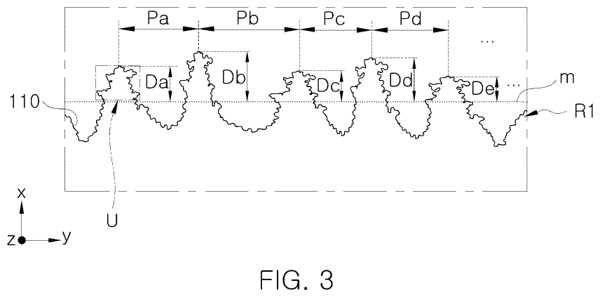

FIG. 3 is a plan view showing an enlarged uneven shape of a first region according to an exemplary embodiment.

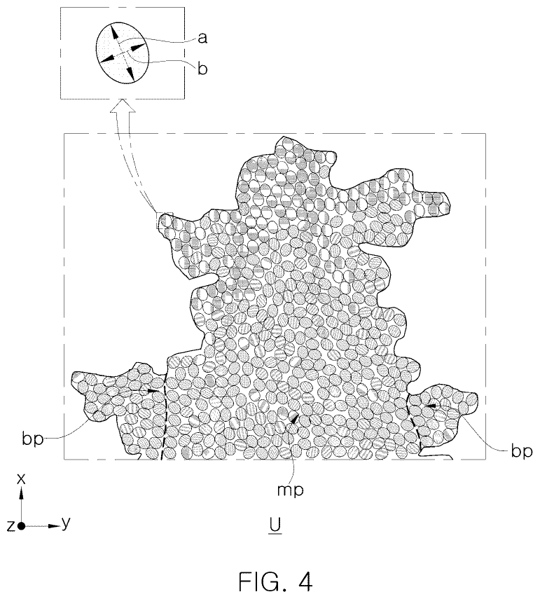

FIG. 4 is an enlarged view of region U in FIG. 3.

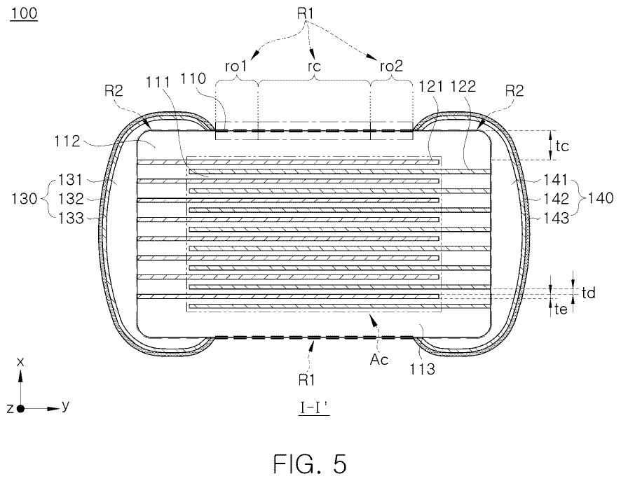

FIG. 5 is a cross-sectional view showing another example for distinguishing the first region according to an exemplary embodiment.

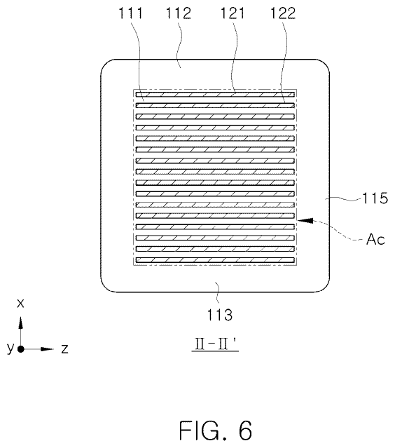

FIG. 6 is a cross-sectional view taken along line II-II′ in FIG. 1.

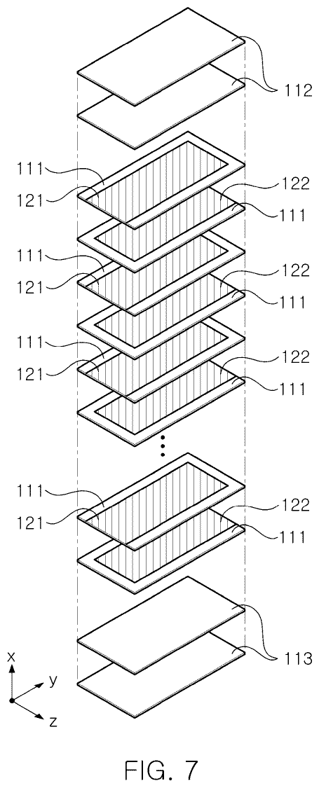

FIG. 7 is an exploded perspective view of a body according to an exemplary embodiment.

Hereinafter, a multilayer electronic component 100 and various exemplary embodiments thereof according to an exemplary embodiment of the present disclosure are described in detail with reference to FIGS. 1 to 7.

The multilayer electronic component 100 according to an exemplary embodiment of the present disclosure may include: a body 110 including a dielectric layer 111 and a first internal electrode 121 and a second internal electrode 122 alternately disposed with the dielectric layer 111 interposed therebetween; a first external electrode 130 disposed on the body 110 and connected to the first internal electrode 121; and a second external electrode 140 disposed on the body 110, connected to the second internal electrode 122, and spaced apart from the first external electrode 130. A first region R1 is a region on a surface of the body 110, disposed between the first external electrode 130 and the second external electrode 140. The first region has an uneven shape including a plurality of peaks and a plurality of valleys. Average depths D1 and D2 are different from each other wherein D1 indicates an average depth of the uneven shape in a central portion rc of the first region R1, and D2 indicates an average depth of the uneven shape in an outer portion ro1 or ro2 of the first region R1. A second region R2 is a region on the surface of the body 110, in contact with the first external electrode 130 or the second external electrode 140.

The multilayer electronic component 100 according to an exemplary embodiment of the present disclosure may include: a body 110 including a dielectric layer 111 and a first internal electrode 121 and a second internal electrode 122 alternately disposed with the dielectric layer 111 interposed therebetween; a first external electrode 130 disposed on the body 110 and connected to the first internal electrode 121; and a second external electrode 140 disposed on the body 110, connected to the second internal electrode 122, and spaced apart from the first external electrode 130, wherein a first region R1 has an uneven shape including a plurality of peaks and a plurality of valleys. The first region R1 is a region on a surface of the body 110, disposed between the first external electrode 130 and the second external electrode 140. A second region R2 is a region on the surface of the body 110, in contact with the first external electrode 130 or the second external electrode 140. Average pitches P1 and P2 are different from each other. An average pitch indicates an average value of a gap between any peak of the uneven shape and a peak adjacent thereto, P1 indicates an average pitch of the uneven shape in a central portion rc of the first region R1, and P2 indicates an average pitch of the uneven shape in an outer portion ro1 or ro2 of the first region R1.

Referring to FIG. 2, the body 110 may include the dielectric layer 111 and the first internal electrode 121 and the second internal electrode 122 alternately disposed with the dielectric layer 111 interposed therebetween.

The body 110 is not particularly limited to a specific shape, and may be formed in a hexahedron or a similar shape as shown in the drawings. Due to shrinkage of a ceramic powder included in the body 110 during a sintering process, the body 110 may have a substantially hexahedron shape, although not a perfect hexahedron having straight lines.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

The plurality of dielectric layers 111 included in the body 110 may be in a sintered state, and a boundary between the adjacent dielectric layers 111 may be integrated, making it difficult to confirm the boundary without using a scanning electron microscope (SEM).

According to an exemplary embodiment of the present disclosure, a raw material included in the dielectric layer 111 is not particularly limited as long as long as sufficient electrostatic capacitance may be obtained. For example, a barium titanate-based material, a lead composite perovskite-based material, or a strontium titanate-based material may be used. The barium titanate-based material may include a BaTiO₃-based ceramic powder, and an example of the ceramic powder may include BaTiO₃ or (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), or the like, in which calcium (Ca), zirconium (Zr), or the like is partially dissolved in BaTiO₃.

In addition, the raw material included in the dielectric layer 111 may be a powder such as barium titanate (BaTiO₃), to which various ceramic additives, organic solvents, binders, dispersants, or the like may be added based on a purpose of the present disclosure.

Meanwhile, the dielectric layer 111 may be in the sintered state, the ceramic powder used as the material of the dielectric layer 111 may form dielectric grains and grain boundaries.

Meanwhile, an average thickness td of the dielectric layer 111 does not need to be particularly limited. For example, the average thickness td of the dielectric layer 111 may be 0.2 μm or more and 2 μm or less, and the average thickness td of the dielectric layer 111 may be 0.35 μm or less in order to more easily achieve high capacity and miniaturization of the multilayer electronic component 100.

Meanwhile, the average thickness td of the dielectric layer 111 may indicate the average thickness td of at least one of the plurality of dielectric layers 111.

The average thickness td of the dielectric layer 111 may be an average value of thicknesses respectively measured at ¼, 2/4, and ¾ points that divide the dielectric layer into four parts in the length direction, based on the dielectric layer at a first-layer position that is adjacent to a point where a center line of a capacitance forming portion in the length direction and a center line of the capacitance forming portion in the thickness direction meet each other, among the dielectric layers extracted from an image obtained by scanning cross-sections of the body 110 in the first direction and the second direction, the cross-sections being polished to the center of the body 110 in the third direction, by using the scanning electron microscope (SEM). The average thickness of the dielectric layer may be further generalized by extending the measurement to two upper and two lower dielectric layers having equal gaps, based on the dielectric layer at the first-layer position that is adjacent to the point where the center line of the capacitance forming portion in length direction and the center line of the capacitance forming portion in the thickness direction meet each other.

The internal electrodes 121 and 122 may be disposed alternately in the first direction with the dielectric layer 111 interposing therebetween.

The internal electrodes 121 and 122 may include the first and second internal electrodes 121 and 122. The first and second internal electrodes 121 and 122 may be alternately disposed to oppose each other with the dielectric layer 111, included in the body 110, interposed therebetween and may be connected to the third and fourth surfaces 3 and 4 of the body 110, respectively. In detail, one end of the first internal electrode 121 may be connected to the third surface, and one end of the second internal electrode 122 may be connected to the fourth surface. That is, in an embodiment, the internal electrodes 121 and 122 may be in contact with the third surface 3 and the fourth surface 4, respectively.

As shown in FIG. 2, the first internal electrode 121 may be spaced apart from the fourth surface 4 and exposed through the third surface 3, and the second internal electrode 122 may be spaced apart from the third surface 3 and may be exposed through the fourth surface 4. The first external electrode 130 may be disposed on the third surface 3 of the body and connected to the first internal electrode 121, and the second external electrode 140 may be disposed on the fourth surface 4 of the body and connected to the second internal electrode 122.

That is, the first internal electrode 121 may connected to the first external electrode 130 rather than being connected to the second external electrode 140, and the second internal electrode 122 may be connected to the second external electrode 140 rather than being connected to the first external electrode 130. Therefore, the first internal electrode 121 may be spaced apart from the fourth surface 4 by a predetermined distance, and the second internal electrode 122 may be spaced apart from the third surface 3 by a predetermined distance. Here, the first and second internal electrodes 121 and 122 may be electrically isolated from each other by the dielectric layer 111 disposed therebetween.

A material included in the internal electrode 121 or 122 is not particularly limited, and a material having excellent electrical conductivity may be used. For example, the internal electrode 121 or 122 may include at least one of nickel (Ni), copper (Cu), palladium (Pd), silver (Ag), gold (Au), platinum (Pt), tin (Sn), tungsten (W), titanium (Ti), or an alloy thereof.

In addition, the internal electrode 121 or 122 may be formed by printing a conductive paste for the internal electrode, which includes at least one of nickel (Ni), copper (Cu), palladium (Pd), silver (Ag), gold (Au), platinum (Pt), tin (Sn), tungsten (W), titanium (Ti), or an alloy thereof, on a ceramic green sheet. A printing method of the conductive paste for the internal electrode may use a screen printing method, a gravure printing method, or the like, and the present disclosure is not limited thereto.

Meanwhile, an average thickness te of the internal electrode 121 or 122 does not need to be particularly limited. For example, the average thickness te of the internal electrode 121 or 122 may be 0.2 μm or more and 2 μm or less, and the average thickness te of the internal electrode 121 or 122 may be 0.35 μm or less in order to more easily achieve the high capacity and miniaturization of the multilayer electronic component 100.

Meanwhile, the average thickness te of the internal electrode 121 or 122 may indicate the average thickness te of at least one of the plurality of internal electrodes 121 and 122.

The average thickness te of the internal electrode 121 or 122 may be an average value of thicknesses respectively measured at ¼, 2/4, and ¾ points that divide the internal electrode into four parts in the length direction, based on the internal electrode at a first-layer position that is adjacent to the point where the center line of the capacitance forming portion in the length direction and the center line of the capacitance forming portion in the thickness direction meet each other, among the internal electrodes extracted from an image obtained by scanning cross-sections of the body 110 in the first direction and the second direction, the cross-sections being polished to the center of the body 110 in the third direction, by using the scanning electron microscope (SEM). The average thickness of the internal electrode may be further generalized by extending the measurement to two upper and two lower the internal electrodes having equal gaps, based on the internal electrode at the first-layer position that is adjacent to the point where the center line of the capacitance forming portion in length direction and the center line of the capacitance forming portion in the thickness direction meet each other.

The body 110 may include a capacitance forming portion Ac in which the capacitance is formed by including the first internal electrode 121 and the second internal electrode 122 that are disposed inside the body 110 and are alternately disposed with the dielectric layer 111 interposed therebetween, and cover portions 112 and 113 disposed on one surface and the other surface of the capacitance forming portion Ac in the first direction, respectively.

The capacitance forming portion Ac is a portion that contributes to forming the capacitance of the capacitor, and may be formed by repeatedly stacking the plurality of first and second internal electrodes 121 and 122 with the dielectric layer 111 interposed therebetween, as shown in FIG. 7.

Referring to FIG. 7, the cover portions 112 and 113 may be formed by stacking a single dielectric layer or two or more dielectric layers on upper and lower surfaces of the capacitance forming portion Ac in the thickness direction, respectively, and may basically function to prevent damage to the internal electrodes caused by physical or chemical stress.

The cover portion 112 or 113 does not include the internal electrode and may include the same material as the dielectric layer 111. That is, the cover portion 112 or 113 may include a ceramic material, for example, a barium titanate (BaTiO₃)-based ceramic material.

Meanwhile, the average thickness of the cover portion 112 or 113 does not need to be particularly limited. However, an average thickness tc of the cover portion 112 or 113 may be 15 μm or less in order to more easily achieve the miniaturization and high capacity of the multilayer electronic component.

The average thickness of the cover portion 112 or 113 may indicate a size of the cover portion 112 or 113 in the first direction, and may be an average value of the sizes of the cover portion 112 or 113 in the first direction, which are measured at five points having equal gaps from the upper or lower portion of the capacitance forming portion Ac.

Referring to FIG. 6, in an exemplary embodiment, margin parts 114 and 115 may be disposed on one surface and the other surface of the capacitance forming portion Ac in the third direction.

Referring to FIG. 6, the margin parts 114 and 115 may include the margin portion 114 disposed on the fifth surface 5 of the body 110 and the margin portion 115 disposed on the sixth surface 6 of the body 110. That is, the margin parts 114 and 115 may be disposed on both cross sections of the body 110 in the third direction (i.e., the width direction).

Meanwhile, the margin portion 114 or 115 may indicate a region between respective ends of the first and second internal electrodes 121 and 122 and a boundary surface of the body 110, as shown in FIG. 6.

The margin portion 114 or 115 may basically function to prevent damage to the internal electrodes caused by the physical or chemical stress.

The margin portion 114 or 115 may be formed by forming the internal electrodes by applying a conductive paste to the ceramic green sheet except for a region where the margin portion is to be formed.

In addition, in order to suppress a step caused by the internal electrodes 121 and 122, the internal electrodes may be stacked and then cut to be exposed through the fifth and sixth surfaces 5 and 6 of the body, and a single dielectric layer or two or more dielectric layers may then be stacked on both sides of the capacitance forming portion Ac in the third direction (i.e., the width direction) to form the margin parts 114 and 115.

A width of the margin portion 114 or 115 does not need to be particularly limited. However, an average width of the margin portion 114 or 115 may be 15 μm or less in order to more easily achieve the miniaturization and high capacity of the multilayer electronic component.

The average width of the margin portion 114 or 115 may indicate an average size of the margin portion 114 or 115 in the third direction, and may be an average value of a sizes of the of the margin portion 114 or 115 in the third direction, which are measured at five points having equal gaps on the side of the capacitance forming portion Ac.

Referring to FIG. 1, the external electrodes 130 and 140 may be disposed on the body 110.

Referring to FIGS. 1 and 2, the external electrodes 130 and 140 may include the first external electrode 130 disposed on the body 110 and connected to the first internal electrode 121, and the second external electrode 140 disposed on the body 110, connected to the second internal electrode 122, and spaced apart from the first external electrode 130.

Here, a direction in which the first external electrode 130 and the second external electrode 140 are spaced apart from each other may be considered as the second direction.

Although the present disclosure describes that the multilayer electronic component 100 has two external electrodes 130 and 140, the number or shape of the external electrode 130 or 140 may vary depending on the shape of the internal electrode 121 or 122 or other purposes.

Referring to FIG. 2, the external electrode 130 or 140 may include an electrode layer 131 or 141 in contact with the third surface 3 of the body or the fourth surface 4 of the body and plating layers 132 and 133 or 142 and 143 disposed on each electrode layer.

For a more specific example of the electrode layer 131 or 141, the electrode layer 131 or 141 may be a fired electrode including a conductive metal and glass, or a resin-based electrode including the conductive metal and resin.

In addition, the electrode layer 131 or 141 may be formed by sequentially forming the fired electrode and the resin-based electrode on the body 110. In addition, the electrode layer 131 or 141 may be formed by transferring a sheet including the conductive metal onto the body 110, or by transferring a sheet including the conductive metal onto the fired electrode.

The conductive metal included in the electrode layer 131 or 141 may be a material having excellent electrical conductivity, and is not particularly limited thereto. For example, the conductive metal may be at least one of nickel (Ni), copper (Cu), or an alloy thereof.

The plating layer 132, 133, 142, or 143 may function to improve mounting characteristics. The plating layer 132, 133, 142, or 143 is not limited to any particular type, may be a plating player including at least one of nickel (Ni), tin (Sn), palladium (Pd), or an alloy thereof, and may include a plurality of layers.

For a more specific example of the plating layer 132, 133, 142, or 143, the plating layers 132, 133, 142, or 143 may be the nickel (Ni) plating layer or the tin (Sn) plating layer, and may include the nickel (Ni) plating layer and the tin (Sn) plating layer, which are sequentially formed on the electrode layer 131 or 141, or may include the tin (Sn) plating layer, the nickel (Ni) plating layer, and the tin (Sn) plating layer, which are sequentially formed on the electrode layer 131 or 141. In addition, the plating layer may include the plurality of nickel (Ni) plating layers and/or the plurality of tin (Sn) plating layers.

Electrochemical ion migration (ECM) is one of failures that occur during an operation of the multilayer electronic component 100, and refers to a phenomenon in which a plating bridge is formed between the external electrodes 130 and 140 as water droplets spread on the surface of the body 110. The ion migration may cause a short circuit between the external electrodes 130 and 140 or increase leakage current, which may deteriorate moisture-resistance reliability of the multilayer electronic component 100.

Conventionally, a method was used to form a water-repellent coating layer on the surface of the body 110 to increase a wetting angle of the water droplets, thus causing the water droplets to spread less on the surface of the body 110, thereby suppressing or delaying occurrence of the ion migration. The water-repellent coating layer is a resin-based coating layer including a fluorine-based or silane-based compound. Accordingly, the water-repellent coating layer may require excessive surface treatment to impart a physical water-repellent property in addition to a chemical water-repellent property, and in this process, the water-repellent coating layer may be peeled off or may be required to have an excessive thickness.

Accordingly, the multilayer electronic component 100 according to an exemplary embodiment of the present disclosure may secure improved moisture-resistance reliability by enabling the surface of the body 110 to include an uneven shape including a plurality of peaks and a plurality of valleys, and by adjusting a specific microstructure of the uneven shape for each position on the surface of the body 110, thereby allowing the surface of the body 110 to have water repellency without including the excessively thick water-repellent coating layer, and allowing the water droplets to move to minimize the occurrence of ion migration.

Hereinafter, the specific microstructure of the uneven shape for each position on the surface of the body 110 is described in detail.

Referring to FIG. 2, the surface of the body 110 according to an exemplary embodiment may be divided into the first region R1 disposed between the first external electrode 130 and the second external electrode 140 and the second region in contact with the first external electrode 130 or the second external electrode 140, and the first region R1 may include the central portion rc and the outer portions ro1 and ro2. Here, the outer portions ro1 and ro2 may be regions disposed on both sides of the central portion rc in the second direction.

Referring to FIG. 3, the first region R1 may include the uneven shape including the plurality of peaks and the plurality of valleys.

The uneven shape in the first region R1 according to an exemplary embodiment of the present disclosure may be adjusted differently based on each specific region of the first region R1. Accordingly, when the water droplets are disposed on the surface of the body 110, a gradient of the wetting angle may be formed based on the position, and this gradient may generate a driving force for moving the water droplets to the center of the surface of the body 110 or the outer portion of the surface of the body 110, thereby suppressing the water droplets spreading on the surface of the body 110 and effectively preventing the occurrence of ion migration in the multilayer electronic component 100.

The present disclosure provides various methods for forming the gradient of the wetting angle based on each position on the surface of the body 110.

In an exemplary embodiment, D1 and D2 may be adjusted to be different from each other when D1 indicates the average depth of the uneven shape in the central portion rc of the first region R1, and D2 indicates the average depth of the uneven shape in the outer portion ro1 or ro2 of the first region R1, thereby forming the gradient of the wetting angle based on the position on the surface of the body 110, and in another exemplary embodiment, P1 and P2 may be adjusted to be different from each other when the average pitch indicates the average value of the gap between any peak of the uneven shape and the peak adjacent thereto, P1 indicates an average pitch of the uneven shape in a central portion rc of the first region R1, and P2 indicates the average pitch of the uneven shape in the outer portion ro1 or ro2 of the first region R1, thereby forming the gradient of the wetting angle based on the position on the surface of the body 110.

In an exemplary embodiment of the present disclosure, a specific shape of the uneven shape in the first region R1 may be expressed by at least one of the average depth and the average pitch, and an example of a method for measuring the average depth or the average pitch based on each position in the first region R1 is as follows.

First, the multilayer electronic component 100 may be polished to the center in the third direction to obtain the cross sections in the first direction and second direction, and surface treatment may then be performed. Next, a central 50 μm×30 μm region of each of the central portion rc and the outer portion ro1 or ro2 in the second direction may be observed at an acceleration voltage of 15 kV and a magnification of 3,000 by using the scanning electron microscope (SEM), and a roughness curve may be formed based on the valley forming the lowest point in the region by using an image processing program such as ImageJ. Next, as shown in FIG. 3, an arithmetic mean of the roughness curve may be obtained to derive an average line m, and a size in first direction from each of the plurality of peaks to the average line m may then be measured as Da, Db, Dc, Dd, De, and the like and a size in the second direction from any peak to the peak adjacent thereto in the second direction may be measured as Pa, Pb, Pc, Pd, and the like. Here, an average depth D and an average pitch P may be expressed as follows.

$$Average depth D = ( Da + Db + Dc + Dd + De … ) / ( number of peaks )$$

$$Average pitch P = ( P a + Pb + Pc + Pd + Pe … ) / ( number of peaks - 1 )$$

Methods for adjusting the average depth and average pitch based on each position in the first region R1 according to an exemplary embodiment of the present disclosure is not particularly limited, and may be implemented, for example, by varying an etching reaction driving force based on each region by using selective wet etching. Adjustment variables of the reaction driving force may be adjusted based on a temperature, a time, or a concentration. In an exemplary embodiment, an immersion (reaction) time for each region in an etching solution may be adjusted by specifically adjusting an immersion height (or a removal speed/time) of the multilayer electronic component 100 when the multilayer electronic component 100 is immersed in the etching solution while being vertically loaded. In another exemplary embodiment, the selective wet etching may also be performed by attaching (masking) a member having a material such as rubber that does not react with the etching solution to a specific surface of the body and adjusting a contact of the member with the liquid.

In an exemplary embodiment, the average depth D2 of the uneven shape in the outer portion ro1 or ro2 may be smaller than the average depth D1 of the uneven shape in the central portion rc. In detail, D1/D2 may be more than 1.0 and less than 10.0 (i.e., in a range from 1.0 to 10.0). In this case, the water droplets formed on the surface of the body 110 may move from the central portion rc a relatively high surface tension to the outer portion ro1 or ro2 having a relatively low surface tension, thereby suppressing or mitigating the ion migration that may occur as the water droplets formed on the surface of the multilayer electronic component 100 spread.

Meanwhile, when D1/D2 is less than or equal to 1.0, it may be difficult to form a driving force sufficient to induce the movement of the water droplets. When D1/D2 is more than or equal to 10.0, there is an increased possibility that the multilayer electronic component 100 may be degraded or cracked during a process of forming the uneven shape in the first region R1. Accordingly, in an exemplary embodiment, D1/D2 may be adjusted to be more than 1.0 and less than 10.0 to make it possible to form the driving force sufficient to induce the movement of the water droplets and simultaneously to suppress or mitigate the degradation or cracking of the multilayer electronic component 100.

In an exemplary embodiment, the average depth D2 of the uneven shape in the outer portion ro1 or ro2 may be greater than the average depth D1 of the uneven shape in the central portion (ro). In detail, D2/D1 may be greater than 1.0 and less than 10.0 (i.e., in a range from 1.0 to 10.0). In this case, the water droplets formed on the surface of the body 110 may move from the outer portion ro1 or ro2 having the relatively high surface tension to the central portion rc having the relatively low surface tension, thereby suppressing or mitigating the ion migration that may occur as the water droplets formed on the surface of the multilayer electronic component 100 spread.

Meanwhile, when D2/D1 is less than or equal to 1.0, it may be difficult to form the driving force sufficient to induce the movement of the water droplets. When D2/D1 is more than 10.0, there is the increased possibility that the multilayer electronic component 100 may be degraded or cracked during the process of forming the uneven shape in the first region R1. Therefore, in an exemplary embodiment, D2/D1 may be adjusted to be more than 1.0 and less than 10.0 to make it possible to form the driving force sufficient to induce the movement of the water droplets and simultaneously to suppress or mitigate the degradation or cracking of the multilayer electronic component 100.

In an exemplary embodiment, the average pitch P2 of the uneven shape in the outer portion ro1 or ro2 may be greater than the average pitch P1 of the uneven shape in the central portion rc. In detail, P1/P2 may be more than 0.1 and less than 0.6. In this case, the water droplets formed on the surface of the body 110 may move from the central portion rc having the relatively high surface tension to the outer portion ro1 or ro2 having the relatively low surface tension, thereby suppressing or mitigating the ion migration that may occur as the water droplets formed on the surface of the multilayer electronic component 100 spread.

If P1/P2 is less than 0.1, there is an increased possibility that the multilayer electronic component 100 may be degraded or cracked during a process of forming an excessive difference in the average pitch for each position. When P1/P2 exceeds 0.6 and approaches 1.0, it may be difficult to form the driving force sufficient to induce the movement of the water droplets.

In an exemplary embodiment, the average pitch P2 of the uneven shape in the outer portion ro1 or ro2 may be smaller than the average pitch P1 of the uneven shape in the central portion rc. In detail, P2/P1 may be more than 0.1 and less than 0.6 (i.e., in a range from 0.1 to 0.6). In this case, the water droplets formed on the surface of the body 110 may move from the outer portion ro1 or ro2 having the relatively high surface tension to the central portion rc having the relatively low surface tension, thereby suppressing or mitigating the ion migration that may occur as the water droplets formed on the surface of the multilayer electronic component 100 spread.

If P2/P1 is less than 0.1, there is the increased possibility that the multilayer electronic component 100 may be degraded or cracked during the process of forming the excessive difference in the average pitch for each position. When P2/P1 exceeds 0.6 and approaches 1.0, it may be difficult to form the driving force sufficient to induce the movement of the water droplets.

Meanwhile, the average depth and average pitch in the central portion rc of the first region R1 and the outer portion ro1 or ro2 may show opposite aspects. In detail, P1/P2 may be more than 0.1 and less than 0.6 (i.e., in a range from 0.1 to 0.6) when D1/D2 is more than 1.0 and less than 10.0, and P2/P1 may be more than 0.1 and less than 0.6 when D2/D1 is more than 1.0 and less than 10.0.

The outer portions ro1 and ro2 of the first region R1 may be divided into the first outer portion ro1 adjacent to the first external electrode 130 and the second outer portion ro2 adjacent to the second external electrode 140, and D2a and P2a indicate the average depth and average pitch of the uneven shape in the first outer portion ro1, respectively, and D2b and P2b indicate the average depth and average pitch of the uneven shape in the second outer portion ro2, respectively.

In an exemplary embodiment, D2a<D1<D2b. In this way, the water droplets formed on the surface of the multilayer electronic component 100 may move toward the second external electrode 140, thereby suppressing or mitigating the ion migration that may occur as the water droplets formed on the surface of the multilayer electronic component 100 spread.

In an exemplary embodiment, D2a>D1 and D2b>D1. In this way, the water droplets formed on the surface of the multilayer electronic component 100 may move toward the first external electrode 130, and accordingly, thereby suppressing or mitigating the ion migration that may occur as the water droplets formed on the surface of the multilayer electronic component 100 spread.

In an exemplary embodiment, P2a<P1<P2b. In this way, the water droplets formed on the surface of the multilayer electronic component 100 may move toward the first external electrode 130, thereby suppressing or mitigating the ion migration that may occur as the water droplets formed on the surface of the multilayer electronic component 100 spread.

In an exemplary embodiment, P2a>P1 and P2b>P1. In this way, the water droplets formed on the surface of the multilayer electronic component 100 may move toward the second external electrode 140, thereby suppressing or mitigating the ion migration that may occur as the water droplets formed on the surface of the multilayer electronic component 100 spread.

Referring to FIG. 2, in an exemplary embodiment, the central portion rc of the first region R1 may be a region disposed at the center when the first region R1 is divided into three parts in the direction in which the first and second external electrodes 130 and 140 are spaced apart from each other, and the outer portions ro1 and ro2 of the first region R1 may be regions disposed on both the sides of the central portion rc when the first region R1 is divided into three parts in the direction in which the first and second external electrodes 130 and 140 are spaced apart from each other.

The central portion rc and outer portion ro1 or ro2 of the first region R1 may be defined differently depending on a separation distance between the first and second external electrodes 130 and 140.

Referring to FIG. 5, in an exemplary embodiment, in the multilayer electronic component 100 having a size enabling the separation distance between the first and second external electrodes 130 and 140 to be 0.1 mm or more and 1.0 mm or less, the outer portions ro1 and ro2 of the first region R1 may be a region extending from an end of the first external electrode 130 to 50 μm and a region extending from an end of the second external electrode 140 to 50 μm, respectively, and the central portion rc of the first region R1 may be a region disposed between the outer portions ro1 and ro2.

In the multilayer electronic component 100 having the size enabling the separation distance between the first and second external electrodes 130 and 140 to be 0.1 mm or more and 1.0 mm or less, the distance between the first external electrode 130 and the second external electrode 140 may be narrow. Therefore, when the water droplets move to the central portion on the surface of the body 110, the effect of suppressing the ion migration may be insufficient due to the sizes of the water droplets themselves. Therefore, when the separation distance between the first and second external electrodes 130 and 140 is 0.1 mm or more and 1.0 mm or less (i.e., in a range from 0.1 mm to 1.0 mm), the water droplets may move to the outer portion ro1 or ro2. That is, in an exemplary embodiment, when the separation distance between the first and second external electrodes 130 and 140 is 0.1 mm or more and 1.0 mm or less (i.e., in a range from 0.1 mm to 1.0 mm), it may satisfy at least one of the condition that D1/D2 is greater than 1.0 and less than 10.0 and the condition that P1/P2 is greater than 0.1 and less than 0.6.

Referring to FIG. 5, in an exemplary embodiment, in the multilayer electronic component 100 having a size enabling the separation distance between the first and second external electrodes 130 and 140 to be more than 1.00 mm, the outer portions ro1 and ro2 of the first region R1 may be a region extending from the end of the first external electrode 130 to 100 μm and a region extending from the end of the second external electrode 140 to 100 μm, respectively, and the central portion rc of the first region R1 may be the region disposed between the outer portions ro1 and ro2.

In the multilayer electronic component 100 having a size enabling the separation distance between the first and second external electrodes 130 and 140 to be more than 1.00 mm, the distance between the first external electrode 130 and the second external electrode 140 may be sufficiently large. Therefore, the water droplets may move to the central portion rc rather than moving to the outer portion ro1 or ro2 in order to prevent the deterioration of the moisture-resistance reliability. That is, in an exemplary embodiment, when the separation distance between the first and second external electrodes 130 and 140 is more than 1.00 mm, it is possible to satisfy at least one of the condition that D2/D1 is more than 1.0 and less than 10.0 and the condition that P2/P1 is more than 0.1 and less than 0.6.

In an exemplary embodiment, D1 and D2 may each be 1 μm or more and 10 μm or less.

When D1 and D2 are each less than 1 μm, the water droplets formed on the surface of the body 110 may fail to form the sufficient surface tension, and when D1 and D2 are each more than 10 μm, there is an increased possibility that the multilayer electronic component 100 may be degraded or cracked.

In an exemplary embodiment, P1 and P2 may be 1 μm or more and 30 μm or less, respectively. When P1 and P2 are each less than 1 μm, there is the increased possibility that the multilayer electronic component 100 may be degraded or cracked, and when P1 and P2 are each more than 10 μm, the water droplets formed on the surface of the body 110 may fail to form the sufficient surface tension.

In an exemplary embodiment, the first region R1 may be a region having the plurality of peaks and the plurality of valleys and indicate a region having a specific depth from an outermost point on an outer surface of the body 110. In detail, in an exemplary embodiment, the first region R1 may indicate a region having a depth of 10 μm or more and 30 μm or less in the first direction from the outermost point on the outer surface of the body 110.

In an exemplary embodiment, the first region R1 may include a plurality of dielectric particles, and the plurality of dielectric particles included in the first region R1 may each have an aspect ratio b/a of 0.8 or more and 1.2 or less. Here, the aspect ratio of the dielectric particle may refer to the ratio b/a of the minor axis length b to major axis length a of the dielectric particles.

In an exemplary embodiment, an average equivalent diameter of the plurality of dielectric particles included in the first region R1 may be 50 nm or more and 400 nm or less. Here, the average equivalent diameter may be calculated by observing the first region R1 using an optical microscope (OM) or the scanning electron microscope (SEM), based on a planimetric method, is not limited thereto, and may be an average value of values measured at two or more points having equal gaps to the left and right in the second direction based on the center of the first region in the second direction.

Referring to FIG. 4, in an exemplary embodiment, the uneven shape may include a main protrusion mp that extends continuously in a direction in which the dielectric layer 111 and the first and second internal electrodes 121 and 122 are alternately disposed, and a branch protrusion bp that protrudes from the main protrusion mp in the direction in which the first and second external electrodes 130 and 140 are spaced apart from each other. Accordingly, the uneven shape may secure a larger surface area than a shape without the branch shape bp. Therefore, the effect of suppressing or mitigating the ion migration according to the present disclosure may be significantly enhanced.

Meanwhile, the branch protrusion bp may be a region branched from the main protrusion mp, and one branch protrusion bp or a plurality of branch protrusions bp may be formed from one main protrusion mp.

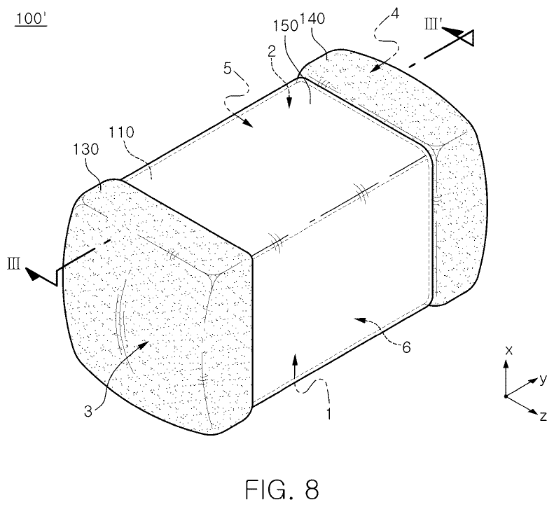

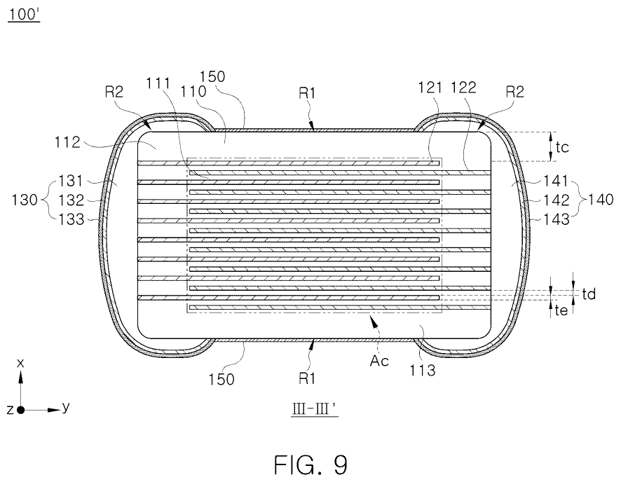

Referring to FIGS. 8 and 9, a coating layer 150 may be disposed in the first region R1 of a multilayer electronic component 100′ according to an exemplary embodiment. Accordingly, the moisture-resistance reliability of the multilayer electronic component 100 may be improved. A component included in the coating layer 150 for improving the moisture-resistance reliability of the multilayer electronic component 100′ is not particularly limited, and for example, the coating layer 150 may include at least one of a fluorine-based resin or the silane-based compound.

A method for forming the coating layer 150 according to an exemplary embodiment is not particularly limited, and for example, the coating layer 150 may be formed by immersing the multilayer electronic component 100 in a solution for forming the coating layer 150, or by using a deposition method.

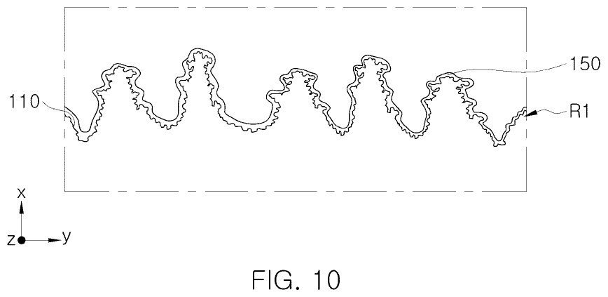

Referring to FIG. 10, in an exemplary embodiment, the coating layer 150 may be formed following the uneven shape of the first region R1. In detail, the coating layer 150 may have the uneven shape in the first region R1, thereby achieving not only the water repellency effect caused by the component included in the coating layer 150, but also the water repellency improvement effect caused by the uneven surface shape of the coating layer 150. Therefore, the moisture-resistance reliability of the multilayer electronic component 100 may be further enhanced. In addition, the driving force for moving the water droplets that may be formed on the surface of the coating layer 150 may be improved. As a result, the ion migration that may occur in the multilayer electronic component 100 may also be more effectively suppressed.

As set forth above, the present disclosure may provide the multilayer electronic component having the improved moisture-resistance reliability by mitigating the occurrence of electrochemical ion migration in the multilayer electronic component.

The present disclosure may also provide the multilayer electronic component that implements the water-droplet movement pattern capable of suppressing the occurrence of ion migration for each size of the multilayer electronic component.

However, various and beneficial advantages and effects of the present disclosure are not limited to those described above, and may be more readily understood in the process of describing the specific exemplary embodiments of the present disclosure.

Although the exemplary embodiments of present disclosure are described in detail above, the present disclosure is not limited to the exemplary embodiments described above and the accompanying drawings, and is limited only by the appended claims. Therefore, it is apparent that various modifications and variations could be made by those skilled in the art without departing from the scope and spirit of the present disclosure as defined by the appended claims. These modifications should also be understood to fall within the scope of the present disclosure.

In addition, the expression “an exemplary embodiment” used in the present disclosure does not indicate that the exemplary embodiments identical to each other, and is provided to emphasize unique features of each exemplary embodiment. However, the exemplary embodiments provided herein do not exclude implementations in combination with features of another exemplary embodiment. For example, one element described in a specific exemplary embodiment may be understood as a description related to another exemplary embodiment even if the element is not described in another exemplary embodiment, unless an opposite or contradictory description is provided therein.

The terms used herein are used only in order to describe an exemplary embodiment rather than to limit the present disclosure. Here, a term of a singular number may include its plural number unless interpreted otherwise in the context.

While the exemplary embodiments have been shown and described above, it will be apparent to those skilled in the art that modifications and variations could be made without departing from the scope of the present disclosure as defined by the appended claims.

What is claimed is:

1. A multilayer electronic component comprising:
a body including a dielectric layer with a first internal electrode and a second internal electrode alternately disposed, with the dielectric layer interposed therebetween;
a first external electrode disposed on the body and connected to the first internal electrode; and
a second external electrode disposed on the body, connected to the second internal electrode, and spaced apart from the first external electrode,
wherein a first region, on a surface of the body, disposed between the first external electrode and the second external electrode, has an uneven shape including a plurality of peaks and a plurality of valleys, and
average depths D1 and D2 are different from each other, wherein D1 indicates an average depth of the uneven shape in a central portion of the first region, and D2 indicates an average depth of the uneven shape in outer portions of the first region.

2. The multilayer electronic component according to claim 1, wherein the central portion of the first region is a region disposed at a center when the first region is divided into three parts in a direction in which the first and second external electrodes are spaced apart from each other, and
the outer portions of the first region are regions disposed on both sides of the central portion in the direction in which the first and second external electrodes are spaced apart from each other.

3. The multilayer electronic component according to claim 1, wherein a separation distance between the first and second external electrodes is 0.1 mm or more and 1.0 mm or less,
the outer portions of the first region are a region extending from an end of the first external electrode to 50 μm and a region extending from an end of the second external electrode to 50 μm, respectively, and
the central portion of the first region is a region disposed between the outer portions.

4. The multilayer electronic component according to claim 1, wherein a separation distance between the first and second external electrodes is more than 1.0 mm,
the outer portions of the first region are a region extending from an end of the first external electrode to 100 μm and a region extending from an end of the second external electrode to 100 μm, respectively, and
the central portion of the first region is a region disposed between the outer portions.

5. The multilayer electronic component according to claim 1, wherein average pitches P1 and P2 are different from each other, wherein an average pitch refers to an average value of a gap between any peak of the uneven shape and a peak adjacent thereto, P1 indicates an average pitch of the uneven shape in the central portion of the first region, and P2 indicates an average pitch of the uneven shape in the outer portion of the first region.

6. The multilayer electronic component according to claim 1, wherein D1/D2 is more than 1 and less than 10.

7. The multilayer electronic component according to claim 6, wherein P1/P2 is more than 0.1 and less than 0.6, wherein an average pitch refers to an average value of a gap between any peak of the uneven shape and a peak adjacent thereto, P1 indicates an average pitch of the uneven shape in the central portion of the first region, and P2 indicates an average pitch of the uneven shape in the outer portion of the first region.

8. The multilayer electronic component according to claim 1, wherein D2/D1 is more than 1 and less than 10.

9. The multilayer electronic component according to claim 8, wherein P2/P1 is more than 0.1 and less than 0.6 when an average pitch refers to an average value of a gap between any peak of the uneven shape and a peak adjacent thereto, P1 indicates an average pitch of the uneven shape in the central portion of the first region, and P2 indicates an average pitch of the uneven shape in the outer portion of the first region.

10. The multilayer electronic component according to claim 1, wherein D2a<D1<D2b, wherein a first outer portion indicates the outer portion of the first region that is adjacent to the first external electrode and a second outer portion indicates the outer portion of the first region that is adjacent to the second external electrode, and wherein D2a indicates an average depth of the uneven shape in the first outer portion and D2b indicates an average depth of the uneven shape in the second outer portion.

11. The multilayer electronic component according to claim 1, wherein D2a>D1 and D2b>D1, wherein a first outer portion indicates the outer portion of the first region that is adjacent to the first external electrode and a second outer portion indicates the outer portion of the first region that is adjacent to the second external electrode, and wherein D2a indicates an average depth of the uneven shape in the first outer portion and D2b indicates an average depth of the uneven shape in the second outer portion.

12. The multilayer electronic component according to claim 1, wherein D1 and D2 are each 1 μm or more and 10 μm or less.

13. The multilayer electronic component according to claim 1, wherein the first region includes a plurality of dielectric particles each having an aspect ratio of 0.8 or more and 1.2 or less.

14. The multilayer electronic component according to claim 13, wherein an equivalent diameter of the plurality of dielectric particles is 50 nm or more and 400 nm or less.

15. The multilayer electronic component according to claim 1, wherein a coating layer is disposed in the first region.

16. The multilayer electronic component according to claim 15, wherein the coating layer includes at least one of silicon (Si) or fluorine (F).

17. The multilayer electronic component according to claim 1, wherein the uneven shape includes a main protrusion that extends continuously in a direction in which the dielectric layer and the first and second internal electrodes are alternately disposed, and a branch protrusion that protrudes from the main protrusion in a direction in which the first and second external electrodes are spaced apart from each other.

18. A multilayer electronic component comprising:
a body including a dielectric layer with a first internal electrode and a second internal electrode alternately disposed, with the dielectric layer interposed therebetween;
a first external electrode disposed on the body and connected to the first internal electrode; and
a second external electrode disposed on the body, connected to the second internal electrode, and spaced apart from the first external electrode,
wherein a first region, on a surface of the body, disposed between the first external electrode and the second external electrode, has an uneven shape including a plurality of peaks and a plurality of valleys when the first region indicates a region, and
average pitches P1 and P2 are different from each other, wherein an average pitch indicates an average value of a gap between any peak of the uneven shape and a peak adjacent thereto, P1 indicates an average pitch of the uneven shape in a central portion of the first region, and P2 indicates an average pitch of the uneven shape in an outer portion of the first region.

19. The multilayer electronic component according to claim 18, wherein P1/P2 is more than 0.1 and less than 0.6.

20. The multilayer electronic component according to claim 18, wherein P2/P1 is more than 0.1 and less than 0.6.

21. The multilayer electronic component according to claim 18, wherein P2a<P1<P2b, wherein a first outer portion indicates the outer portion of the first region that is adjacent to the first external electrode and a second outer portion indicates the outer portion of the first region that is adjacent to the second external electrode, and wherein P2a indicates an average pitch of the uneven shape in the first outer portion and P2b indicates an average pitch of the uneven shape in the second outer portion.

22. The multilayer electronic component according to claim 18, wherein P2a>P1 and P2b>P1, wherein a first outer portion indicates the outer portion of the first region that is adjacent to the first external electrode and a second outer portion indicates the outer portion of the first region that is adjacent to the second external electrode, and wherein P2a indicates an average pitch of the uneven shape in the first outer portion and P2b indicates an average pitch of the uneven shape in the second outer portion.

23. The multilayer electronic component according to claim 18, wherein P1 and P2 are each 1 μm or more and 30 μm or less.

24. The multilayer electronic component according to claim 18, wherein the first region includes a plurality of dielectric particles each having an aspect ratio of 0.8 or more and 1.2 or less.

25. The multilayer electronic component according to claim 24, wherein an equivalent diameter of the plurality of dielectric particles is 50 nm or more and 400 nm or less.

26. The multilayer electronic component according to claim 18, wherein a coating layer is disposed in the first region.

27. The multilayer electronic component according to claim 26, wherein the coating layer includes at least one of silicon (Si) or fluorine (F).

28. The multilayer electronic component according to claim 18, wherein the uneven shape includes a main protrusion that extends continuously in a direction in which the dielectric layer and the first and second internal electrodes are alternately disposed, and a branch protrusion that protrudes from the main protrusion in a direction in which the first and second external electrodes are spaced apart from each other.
